(19) United States
(12) Patent Application Publication
(10) Pub. No.: US 2006/0018212 A1
(43) Pub. Date: Jan. 26, 2006

(54) Focus error detecting device and optical pickup apparatus provided with the same

(75) Inventors: Kazuhiro Tsuchida, Higashihiroshima-shi (JP); Satoru Fukumoto, Higashihiroshima-shi (JP); Katsushige Masui, Higashihiroshima-shi (JP); Kazunori Matsubara, Shiki-gun (JP); Keiji Sakai, Nara-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/176,938

(22) Filed: Jul. 8, 2005

(30) Foreign Application Priority Data
Jul. 8, 2004 (JP) P2004-201949

(51) Int. Cl. G11B 7/00

(52) U.S. Cl. 369/44.27; 369/112.01

(57) ABSTRACT

A focus error detecting device which can realize stable focus servo without causing a deterioration in the quality of a signal, is provided. The focus error detecting device outputs a reflected light detection result by an optical recording medium to control a distance between an objective lens and the optical recording medium. With respect to the focus error detecting device, between the objective lens and two split light-receiving segments, is provided a hologram element for bending an optical path so that part of light reflected by the optical recording medium enters the two split light-receiving segments, and splitting a light beam of reflected light entering the two split light-receiving segments into a plurality of parts.

### BACKGROUND OF THE INVENTION

1. Field of the Invention

The present invention relates to a focus error detecting device and an optical pickup apparatus provided with the same.

2. Description of the Related Art

For example, in an optical pickup apparatus installed in an optical information recording-reproducing apparatus recording information on and/or reproducing information from an optical recording medium such as a compact disk (abbreviated to CD) and a digital versatile disk (abbreviated to DVD), focus servo is performed in order to make the spot of, for example, laser light emitted from a light source focused on the information recording surface of an optical recording medium. Focus servo is realized by detecting reflected light which is reflected by an optical recording medium as a focus error signal by the use of a photodetector and moving an actuator equipped with an objective lens in response to the focus error signal in the direction close to or away from the optical recording medium.

For detection of a focus error signal, the astigmatic method, the knife edge method and so on are widely used. FIGS. 5A to 5C are views describing the overview of a focus error detecting method by the conventional knife edge method. FIG. 5A shows a state where a light spot is focused in a position closer to (nearer) an objective lens 2 than an information recording surface 1 of an optical recording medium, FIG. 5B shows a state where a light spot is focused exactly on the information recording surface 1 of the optical recording medium, and FIG. 5C shows a state where a light spot is focused in a farther position than the information recording surface 1 of the optical recording medium relative to the objective lens 2.

In the focus error detection by the conventional knife edge method, part of reflected light which is reflected by the optical recording medium, transmitted by the objective lens 2 and a collimating lens 3, and condensed on two split light-receiving elements 5a, 5b is blocked by a shielding plate 4 referred to as a knife edge.

FIGS. 6A to 6C are views showing the states of light spots on the two split light-receiving elements 5a, 5b corresponding to the respective focus positions on the optical recording medium shown in FIGS. 5A to 5C. FIG. 6A shows a light spot 6a on the two split light-receiving elements 5a, 5b in the case where it is focused on the nearer position mentioned before, FIG. 6B shows a light spot 6b on the two split light-receiving elements 5a, 5b in the case where it is focused on the information recording surface of the optical recording medium, and FIG. 6C shows a light spot 6c on the two split light-receiving elements 5a, 5b in the case where it is focused on the farther position.

The shape of a light spot on the two split light-receiving elements 5a, 5b changes in the order of the semicircle 6a, the circle (dot) 6b and the reversed semicircle 6c depending on the focus state, that is, depending on the distance between the objective lens 2 and the optical recording medium. Therefore, it is possible to generate a focus error signal by a difference in output between a signal detected on one of the two split light-receiving elements 5a, 5b and a signal detected on the other.

FIG. 7 is a view showing an example of focus error signals by the conventional knife edge method. In FIG. 7, the horizontal axis (x-axis) shows the distance between the objective lens 2 and the optical recording medium, and the vertical axis (y-axis) shows the strength of a signal. A line 7 in FIG. 7 shows focus error signals, and the focus error signals present a substantially S-like shape. The characteristic of the focus error signals presenting a substantially S-like shape is determined by three elements of a straight line range L1, a drawn range L2 and sensitivity a described below.

The straight line range L1 is a range where the strength of a signal detected in association with the distance between the objective lens 2 and the optical recording medium has a proportional relation increasing and decreasing linearly. The drawn range L2 is a range where a portion slightly deviating from the proportional relation is included but the distance between the objective lens 2 and the optical recording medium and the strength of a detected signal has such a significant relation as usable for control of focus servo. The sensitivity a is given on the basis of a gradient formed by the portion of the straight line range L1 of the line 7 as focus error signals and the horizontal axis (x-axis)

The drawn range L2, the straight line range L1 and the sensitivity a of focus error signals are influenced by an optical system, the distance between the light receiving element 5a and the light receiving element 5b and so on. The optical system is determined by a spot diameter emitted from the objective lens 2, an optical output and so on. The distance between the two split light-receiving elements 5a, 5b has an influence on the frequency characteristic of the light receiving elements.

Since the characteristic of focus error signals by the conventional knife edge method is decided by the optical system, the interval between the light receiving elements and so on, there is a case where it is difficult to obtain an optimum characteristic, and a focus servo characteristic may be adversely affected resulting from such characteristics that the sensitivity a in the straight line range is high, the straight line range L1 is narrow and the drawn range L2 is narrow. For example, in the case where such a performance is necessary that the optical system is high-powered and the frequency characteristic of the light receiving elements is high, a proper characteristic of focus error signals cannot be obtained, with the result that such a problem may occur that servo becomes unstable or servo does not start at the time of reproduction from or writing into the optical recording medium.

In one of the related arts solving the problem, a band-like portion near the center of reflected light from a recording medium is split off by light beam region splitting means and detected by focus detecting means, and a focus signal is generated {refer to Japanese Unexamined Patent Publication JP-A 9-180241 (1997)}.

FIGS. 8A and 8B are views showing the overview of generation of a focus signal in an optical pickup 10 in the related art. In the optical pickup 10, reflected light from a recording medium is transmitted by a detecting lens 11 and split into a band-like portion near the center and the remaining portion by light beam region splitting means 12, the band-like portion near the center of the light is detected by a two-part split light receiving element 13, and the remaining portion of the light is detected by another light receiving element 14.

The light beam region splitting means 12 includes a transparent board 15, and a flat-plate mirror 16 disposed on a surface of the transparent board 15 facing the detecting lens 11. The flat-plate mirror 16 is composed of a band-like transmitting portion 16a in the center thereof, and a reflecting film 16b disposed on both sides of the band-like transmitting portion 16a. Light transmitted by the transmitting portion 16a and the transparent board 15 is detected by the two-part split light receiving element 13 as mentioned before, and a focus signal is generated on the basis of a difference in output signal between the respective split parts. The remaining light reflected by the reflecting film 16b is detected by the other light receiving element 14, and a reproduction signal and a track signal are generated by output signals thereof.

In the optical pickup 10, reduction of the sensitivity is realized by splitting light reflected by the use of the light beam region splitting means 12 and decreasing the amount of light received by the two-part split light receiving element 13 for generation of a focus signal.

However, the optical pickup 10 disclosed in JP-A 9-180241 has a problem as described below. Since light reflected by a recording medium is split by the light beam region splitting means 12, a focus signal is generated by the band-like portion in the center of the light, and a reproduction signal and a track signal are generated by the remaining light, there is a problem that the amount of light used for generation of a reproduction signal becomes small only in the band-like portion in the center and the quality of a reproduction signal deteriorates. Moreover, the light receiving elements are separately disposed in two places for the two-part split light receiving element 13 for generation of a focus signal and the other light receiving element 14 for generation of a reproduction signal and a track signal, and spaces for disposing the light receiving elements in two places are necessary, so that there is a problem that miniaturization is hindered.

### SUMMARY OF THE INVENTION

An object of the invention is to provide a focus error detecting device which can realize stable focus servo without causing a deterioration in the quality of a signal, and an optical pickup apparatus provided with the same.

FIGS. 9A to 9D are views showing the relation among light entering two split light-receiving elements a, b, outputs from the respective light receiving elements a, b and focus error signals in the case where the distance between an objective lens 21 and an optical recording medium 22 changes. FIGS. 9A to 9D show states in each of which one light beam such that reflected light which is reflected by the optical recording medium 22 is transmitted by the objective lens 21 and a collimating lens 23 again and split off by a semicircle region of a hologram pattern formed on a hologram element 24 enters the two split light-receiving elements a, b.

In the process where a positional relation between the objective lens 21 and the optical recording medium 22 changes from a near position to a far position via a focus position, as shown in FIG. 9B: a light spot by the one light beam split off by the hologram element 24 enters the light receiving element a in the shape of a semicircle, and the shape becomes smaller; subsequently, the shape becomes a dot-like shape, and the light spot enters both the light receiving element a and the light receiving element b; and then, the light spot enters the light receiving element b in the shape of a semicircle, and the shape becomes larger.

The respective outputs of the light receiving element a and the light receiving element b on this occasion are obtained as shown in FIG. 9C. A focus error signal is obtained on the basis of a difference in outputs between the light receiving element a and the light receiving element b, and obtained as shown by a line 25 in FIG. 9D. In the case of obtaining the focus error signals 25 by causing the one light beam split off by the hologram element 24 to enter the two split light-receiving elements a, b, sensitivity α1 is high, and a drawn range is narrow, as mentioned before.

However, by causing a plurality of light beams split by a hologram element to enter two split light-receiving elements, it becomes possible to change the characteristic of focus error signals.

FIGS. 10A to 10D are views showing the relation among light beams entering the two light receiving elements a, b, outputs from the respective light receiving elements a, b and focus error signals in the case of causing the plurality of light beams split by a hologram element 26 to enter the two split light-receiving elements a, b.

The hologram element 26 and the two split light-receiving elements a, b are placed so that light spots by a plurality of light beams split by the hologram element 26 enter both the two split light-receiving elements a, b (the amounts of lights entering the respective light receiving elements a, b are different) In the process where a positional relation between the objective lens 21 and the optical recording medium 22 changes from a near position to a far position via a focus position, as shown in FIG. 10B: the plurality of light spots formed by the plurality of light beams enter in the shapes of semicircles, and the shapes become smaller; subsequently, they become dot-like shapes; further, they become reversed semicircles and become larger. However, unlike in FIG. 9B mentioned before, the plurality of light spots always enter both the light receiving element a and the light receiving element b.

As to the outputs of the respective light receiving elements a, b on this occasion, as shown in FIG. 10C, in accordance with a change of the distance between the objective lens 21 and the optical recording medium 22, for example, a change from the near position to the focus position, the output of the light receiving element a increases, and also the output of the light receiving element b increases. Therefore, a change of focus error signals shown by a line 27 in FIG. 10D is small, and it is possible to decrease sensitivity α2 thereof. Focus error signals 25 in FIG. 10D are the same as the foregoing focus error signals 25 in FIG. 9D, and are illustrated for comparison.

An amplitude w2 of the focus error signals 27 becomes smaller than an amplitude w1 of the foregoing focus error signals 25 obtained in the case of one light beam, but the sensitivity becomes lower, and it is possible to make a drawn range wider. Moreover, the sum of the amounts of light beams entering the respective light receiving elements a, b does not become smaller than in the foregoing case of one light beam, so that a deterioration is not caused in the quality of a reproduction signal and a track error signal.

That is to say, by causing light beams formed by splitting light reflected by the optical recording medium into multiple parts to enter the two split light-receiving elements, it is possible to cause a light beam having a virtually large cross section to enter the two split light-receiving elements in both the focus position and the near (far) position, so that it is possible to make the sensitivity of focus error signals small.

The inventors completed the invention on the basis of the knowledge as described above.

The invention provides a focus error detecting device comprising:

a light source for emitting light;

an objective lens for condensing light emitted from the light source on a reflector;

a two-part split photodetector for enter of part of light reflected by the reflector thereinto and outputting a reflected light detection result, to control a distance between the objective lens and the reflector; and

light beam splitting means disposed between the objective lens and the two-part split photodetector, for bending an optical path so that part of light reflected by the reflector enters the two-part split photodetector, and splitting a light beam of reflected light entering the two-part split photodetector, into a plurality of parts.

Further, in the invention, it is preferable that the light beam splitting means is a hologram element provided with a hologram pattern having regions split into a plurality of parts.

Furthermore, in the invention, it is preferable that the hologram pattern has a splitting line which splits the hologram pattern into at least two regions, and a light beam split into a plurality of parts by the hologram element is condensed on the hologram pattern so as to have equal areas on both sides of a virtual line orthogonal to the splitting line.

Still further, in the invention, it is preferable that the hologram pattern is formed into a circle, and the splitting line extends in parallel to the diameter in a position which is at a predetermined distance away from a center of the circle of the hologram pattern.

Still further, in the invention, it is preferable that a plurality of light beams split by the light beam splitting means, in cross sections perpendicular to optical axes of the light beams, are of fan-shapes which are formed by splitting a substantially semicircle and have equal areas to each other.

Still further, in the invention, it is preferable that a plurality of light beams split by the light beam splitting means form, in cross sections perpendicular to the optical axes of the light beams, concentric circles or parts of concentric circles.

Still further, the invention provides an optical pickup apparatus which records information on an optical recording medium and/or reproduces information from an optical recording medium by the use of light, the optical pickup apparatus comprising one of the above mentioned focus error detecting devices.

According to the invention, a focus error detecting device comprises light beam splitting means disposed between an objective lens and a two-part split photodetector, for bending an optical path so that part of light reflected by a reflector enters the two-part split photodetector, and splitting a light beam of reflected light entering the two-part split photodetector into a plurality of parts. Consequently, it is possible to cause a plurality of light beams split into multiple parts to enter the receiving element of the two-part split photodetector in both a focus position and a near (far) position as a light beam having a virtually large cross section, so that it becomes possible to make the sensitivity of focus error signals small, and stably perform detection of focus error signals.

Still further, according to the invention, the light beam splitting means is realized by a hologram element provided with a hologram pattern having regions split into a plurality of parts, so that it is possible to split reflected light into a plurality of light beams with a simple configuration.

Still further, according to the invention, the hologram pattern has a splitting line which splits the hologram pattern into at least two regions, and a light beam split into a plurality of parts by the hologram element is condensed on the hologram pattern so as to have equal areas on both sides of a virtual line orthogonal to the splitting line, so that it is possible to obtain a focus error signal with high accuracy. Still further, the hologram pattern is formed into a circle, and the splitting line extends in parallel to the diameter in a position which is at a predetermined distance away from the center of the circle of the hologram pattern. Therefore, it is possible to align the center of the hologram pattern with the center of light reflected by a reflector.

Still further, according to the invention, a plurality of light beams split by the light beam splitting means, in cross sections perpendicular to the optical axes of the light beams, are of fan-shapes which are formed by splitting a substantially semicircle and have areas equal to each other, whereby it is possible to easily achieve both reduction in sensitivity of focus error signals and security of linearity thereof.

Still further, according to the invention, by splitting into a plurality of light beams by the light beam splitting means so that the cross sections perpendicular to the optical axes of the light beams form concentric circles or parts of concentric circles, it is possible to increase symmetry of light, and stabilize the characteristic of focus error signals.

Still further, according to the invention, an optical pickup apparatus is equipped with the above mentioned focus error detecting devices, so that such an optical pickup is realized that can stably perform focus servo without a deterioration in the quality of a signal.

### BRIEF DESCRIPTION OF THE DRAWINGS

Other and further objects, features, and advantages of the invention will be more explicit from the following detailed description taken with reference to the drawings wherein:

FIG. 1 is a simplified perspective view showing the configuration of an optical pickup apparatus comprising a focus error detecting device according to a first embodiment of the invention;

FIG. 2 is a plan view showing the configuration of light beam splitting means provided in the focus error detecting device of FIG. 1;

FIG. 3 is a view showing, with light spots, positions in which light beams split by the first to eighth fan-shape regions fall on the two split light-receiving segments in the case of a focus state on the information recording surface of the optical recording medium;

FIG. 4 is a plan view showing the configuration of a hologram element of a focus error detecting device installed in an optical pickup apparatus according to a second embodiment of the invention;

FIGS. 5A to 5C are views describing the overview of a focus error detecting method by the conventional knife edge method;

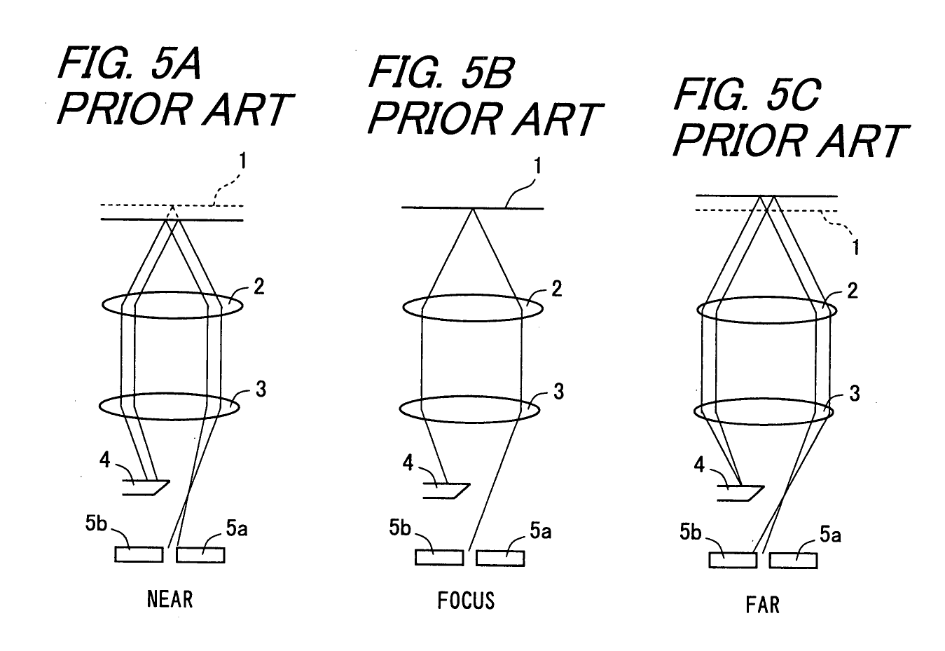

FIGS. 6A to 6C are views showing the states of light spots on the two split light-receiving elements corresponding to the respective focus positions on the optical recording medium shown in FIGS. 5A to 5C;

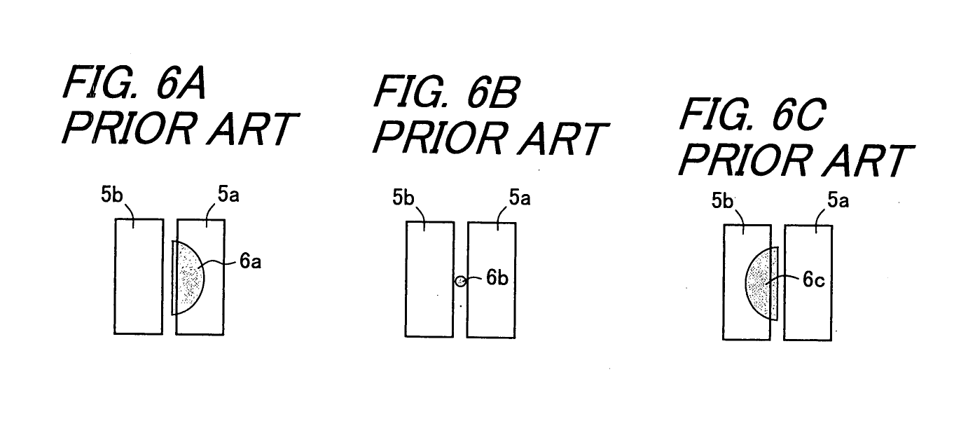

FIG. 7 is a view showing an example of focus error signals by the conventional knife edge method;

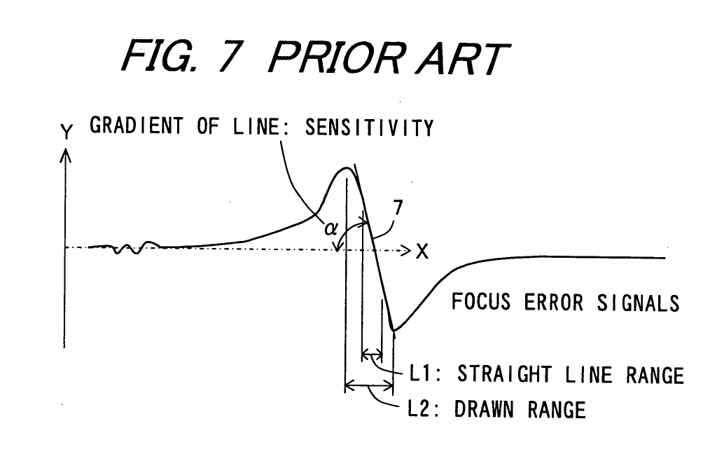

FIGS. 8A and 8B are views showing the overview of generation of a focus signal in an optical pickup in the related art;

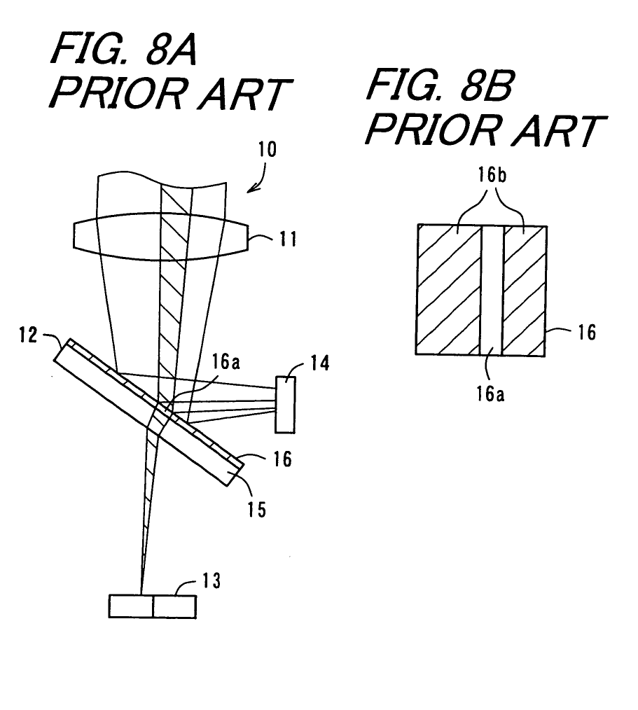

FIGS. 9A to 9D are views showing the relation among light entering two split light-receiving elements, outputs from the respective light receiving elements and focus error signals in the case where the distance between an objective lens and an optical recording medium changes; and

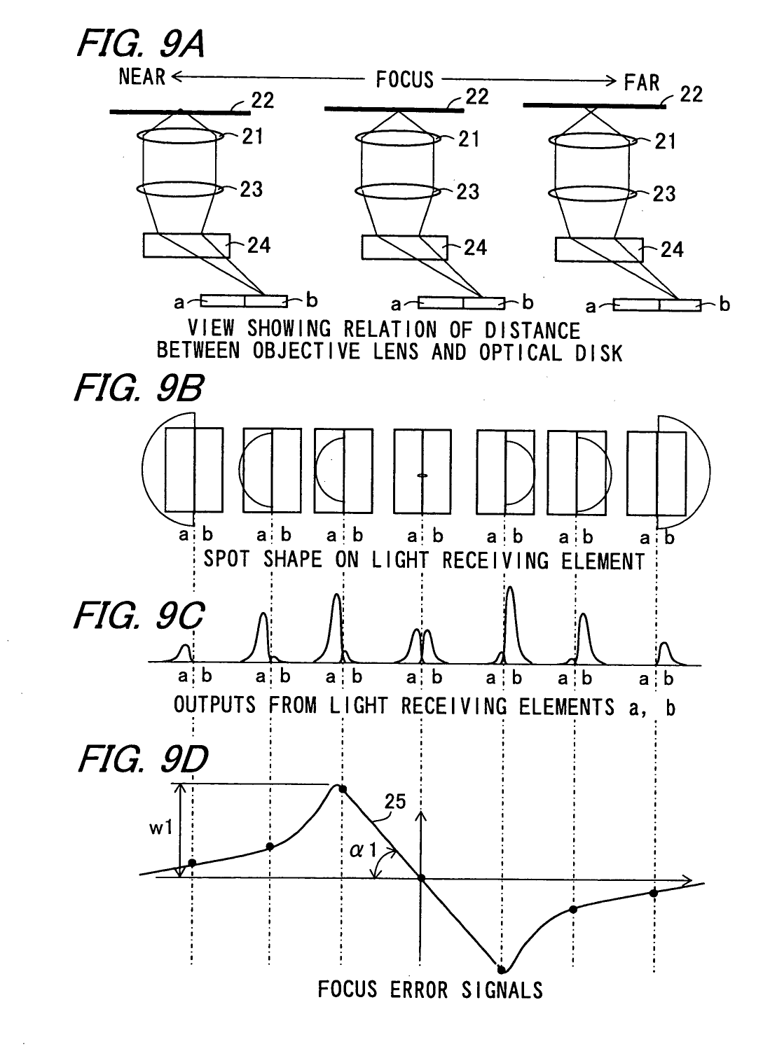

FIGS. 10A to 10D are views showing the relation among light beams entering the two light receiving elements, outputs from the respective light receiving elements and focus error signals in the case of causing a plurality of light beams split by a hologram element to enter the two split light-receiving elements.

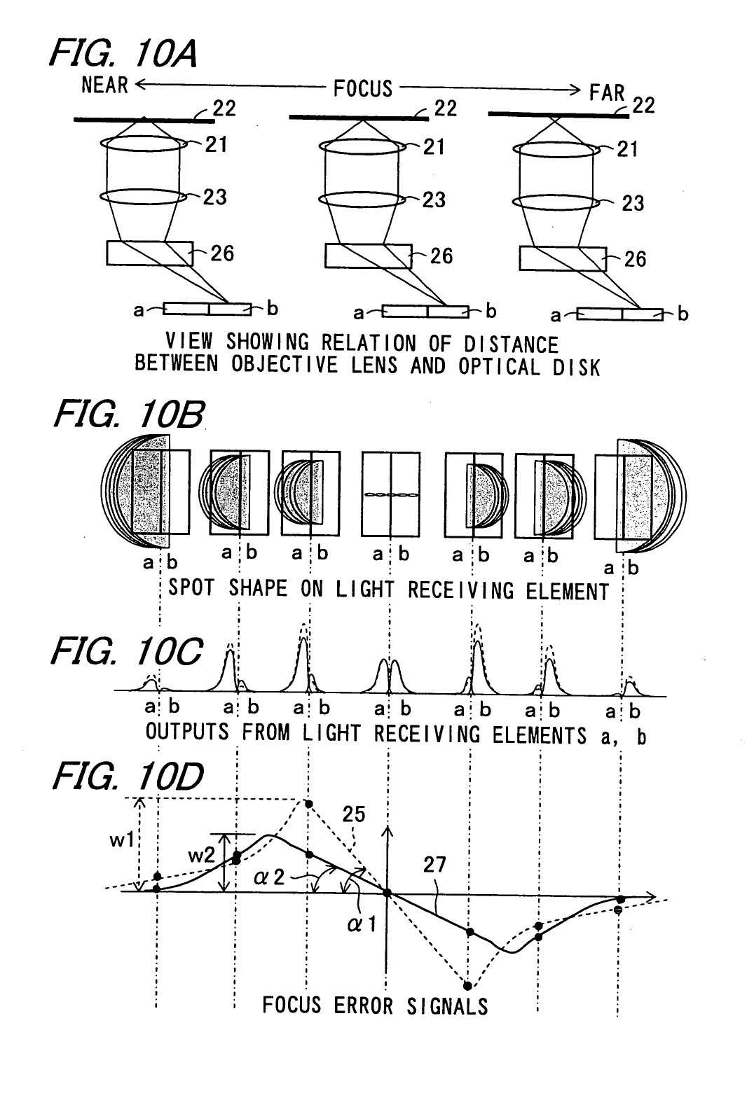

### DETAILED DESCRIPTION

Now referring to the drawings, preferred embodiments of the invention are described below.

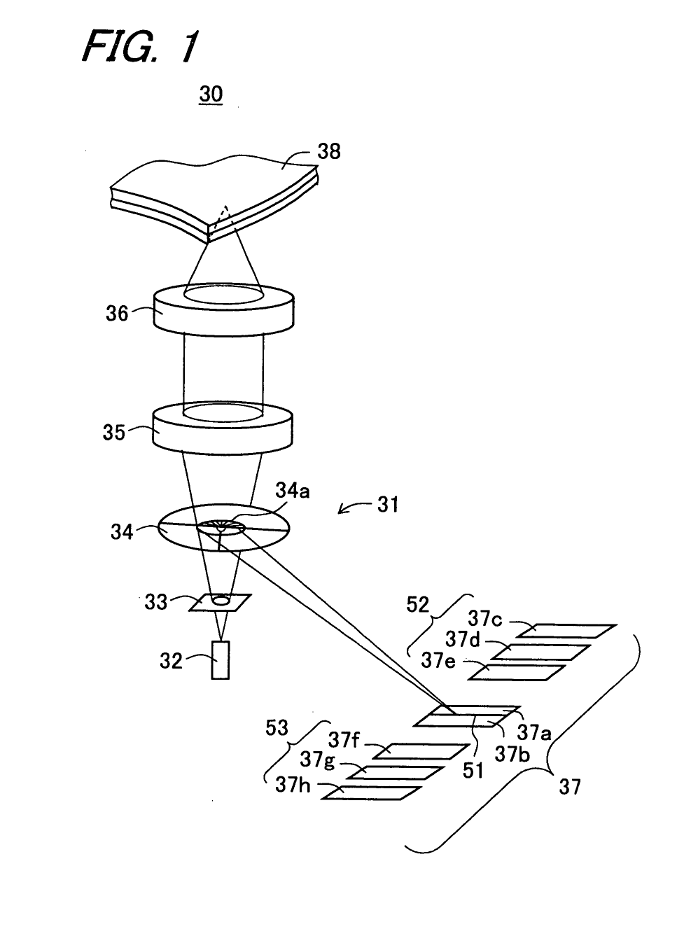

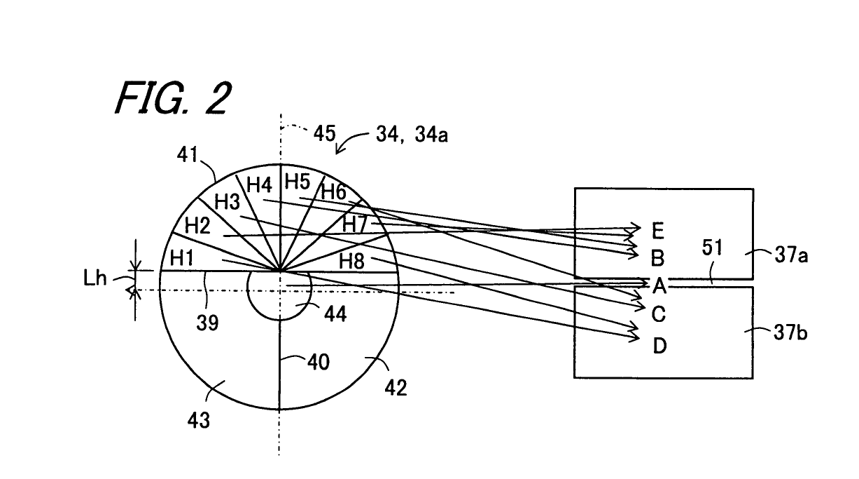

FIG. 1 is a simplified perspective view showing the configuration of an optical pickup apparatus 30 comprising a focus error detecting device 31 according to a first embodiment of the invention, and FIG. 2 is a plan view showing the configuration of light beam splitting means 34 provided in the focus error detecting device 31 of FIG. 1.

The optical pickup apparatus 30 comprises a light source 32, a grating 33, a collimating lens 35, an objective lens 36, light beam splitting means 34, and a photodetector 37. The light source 32 emits light. The grating 33 diffracts light emitted from the light source 32 and branches the light. The collimating lens 35 substantially collimates light. The objective lens 36 condenses light transmitted by the collimating lens 35 on the information recording surface of an optical recording medium 38. The light beam splitting means 34 splits reflected light which is reflected by the optical recording medium 38 and transmitted by the objective lens 36 and the collimating lens 35 again into a plurality of light beams. The photodetector 37 receives the reflected light which is split and whose optical path is bent by the light beam splitting means 34.

The light source 32 is, for example, a semiconductor laser which emits infrared light whose wavelength is 780 nm for a CD as the optical recording medium 38, red light whose wavelength is 650 nm for a DVD, or the like. The grating 33 is a diffraction grating which branches light emitted from the light source 32 into a main beam and two sub beams in the case where tracking servo is performed by, for example, the three-beam method.

In the present embodiment, the light beam splitting means 34 is a hologram element provided with a hologram pattern having regions split into a plurality of parts. A hologram pattern 34a of the hologram element 34 has a plan-viewed shape formed into a circle.

The circular hologram pattern 34a is split into two parts of a first region 41 and the remaining region by a first splitting line 39 that extends in parallel to the diameter in a position slightly away from the center of the circle in the radial direction, and further, the remaining region is split into a second region 42 and a third region 43 by a second splitting line 40 that is orthogonal to the first splitting line 39.

The first splitting line 39 is formed at a distance of Lh away from the center of the circle, in order to align the center of the hologram pattern 34a with the center of light reflected by the optical recording medium 38, and in the present embodiment, the distance Lh is set to 78 μm. In the hologram pattern 34a, apart from the first to third regions 41, 42, 43, an arched small region 44 including the center of the hologram pattern 34a is formed. The small region 44 is disposed in order to, at the time of reproduction of information from an optical recording medium having a plurality of information recording surfaces, prevent reflected light from an information recording surface on which a light spot is not focused from adversely affecting a track servo signal.

The hologram element 34 is placed so that the first splitting line 39 of the hologram pattern 34a extends in the direction orthogonal to a track formed on the information recording surface of the mounted optical recording medium 38.

The first region 41 of the hologram pattern 34a is further split into eight parts having equal areas to each other, that is, first to eighth fan-shape regions H1, H2, H3, H4, H5, H6, H7, H8 (split into eight parts in the present embodiment, but may be split into more parts). Consequently, reflected light entering the hologram element 34 is split into a plurality of light beams having, in cross sections perpendicular to the optical axes of the light beams, fan-shapes which are formed by splitting a substantially semicircle and have equal areas to each other.

Further, a light beam split into eight fan-shapes by the first to eighth fan-shape regions H1 to H8 formed on the first regions 41 of the hologram pattern 34a is condensed on the hologram pattern 34a so as to have equal areas on both sides of a virtual line 45 (corresponding to the extension line of the second splitting line 40 in the present embodiment) that is orthogonal to the first splitting line 39. That is to say, the sum of the areas of the first to fourth fan-shape regions H1 to H4 that reflected light to be split enters becomes equal to the sum of the areas of the fifth to eighth fan-shape regions H5 to H8 that the reflected light to be split enters.

The photodetector 37 that receives and detects a plurality of light beams split by the hologram element serving as the light beam splitting means 34 is, for example, a light receiving element which includes a plurality of light receiving segments formed by photodiodes or the like.

In the present embodiment, the light receiving element 37 is configured so as to include two split light-receiving segments 37a, 37b that serve as split photodetector and the remaining six light receiving segments 37c, 37d, 37e, 37f, 37g, 37h. The six light receiving segments 37c, 37d, 37e, 37f, 37g, 37h are arranged in the direction orthogonal to a segment splitting line 51 that splits the two split light-receiving segments 37a, 37b into two parts, as well as placed so that a first light receiving segment group 52 composed of the three light receiving segments 37c, 37d, 37e and a second light receiving segment group 53 composed of the three light receiving segments 37f, 37g, 37h are symmetrical about the two split light-receiving segments 37a, 37b.

The light source 32, the hologram element 34, the objective lens 36, and the light receiving element 37 serving as a photodetector configure the focus error detecting device 31. The optical recording medium 38 serving as a reflector is also included as a focus object in the focus error detecting device 31 by necessity.

Light beams split and diffracted by the first to eighth fan-shape regions H1 to H8 formed by splitting the first region 41 of the hologram pattern 34a into eight parts, respectively, are caused to enter the two split light-receiving segments 37a, 37b so as to be arranged in the direction perpendicular to the segment splitting line 51 (hereinafter, entering the light receiving segment may be referred to as falling on the light receiving segment).

As to the falling positions of light beams on the two split light-receiving segments 37a, 37b, a position on the segment splitting line 51 is defined as a position A, positions on the light receiving segment 37a are defined as positions B, E in the order of small isolation distance from the position A in the direction perpendicular to the segment splitting line 51, and positions on the light receiving segment 37b are defined as positions C, D in the order of small isolation distance from the position A in the direction perpendicular to the segment splitting line 51.

Light beams diffracted by the respective regions of the first to eighth fan-shape regions H1 to H8 fall on the respective positions shown in Table 1. That is to say, light beams diffracted by the fourth and fifth fan-shape regions H4, H5 fall on the position B, light beams diffracted by the third and sixth fan-shape regions H3, H6 fall on the position C, light beams diffracted by the second and seventh fan-shape regions H2, H7 fall on the position E, and light beams diffracted by the first and eighth fan-shape regions H1, H8 fall on the position D. Moreover, a light beam diffracted by the small region 44 falls on the position A.

TABLE 1

| Split region in | Falling position of |
|---|---|
| hologram pattern | light beam |
| H1 | D |
| H2 | E |
| H3 | C |
| H4 | B |
| H5 | B |
| H6 | C |
| H7 | E |
| H8 | D |
| 44 | A |

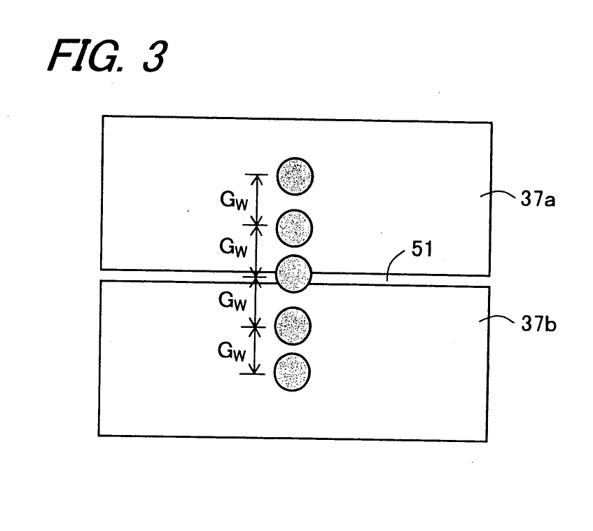

FIG. 3 is a view showing, with light spots, positions in which light beams split by the first to eighth fan-shape regions Hi to H8 fall on the two split light-receiving segments 37a, 37b in the case of a focus state on the information recording surface of the optical recording medium 38.

A focus error signal can be obtained on the basis of a difference in detection output of lights falling on the two split light-receiving segments 37a, 37b, but there is an optimum value as a falling interval Gw of light beams arranged in the direction perpendicular to the segment splitting line 51, and when the falling interval Gw becomes too large, an inflection point appears in a straight line range of focus error signals and linearity thereof is impaired also, this phenomenon occurs when a beam of a straight line range portion and a beam of a peak portion are superposed because observed focus error signals are superposition of focus error signals generated by individual beams split into multiple parts. On the contrary, when the falling interval Gw becomes small, it is impossible to obtain a virtual large beam, so that an effect of lowering the sensitivity of focus error signals becomes small. Accordingly, in order to achieve both a reduction in sensitivity and security of linearity, there is an optimum value as mentioned before, and as an example of a set value in the present embodiment, the falling interval Gw is 3 μm.

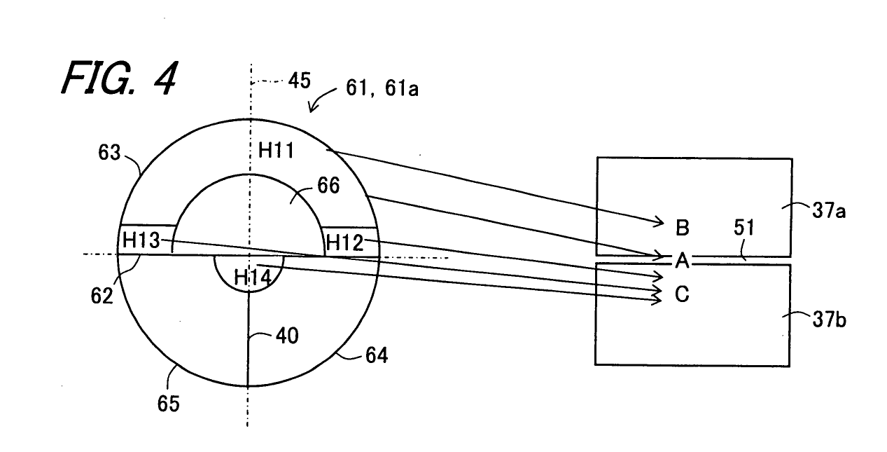

FIG. 4 is a plan view showing the configuration of a hologram element 61 of a focus error detecting device installed in an optical pickup apparatus as a second embodiment of the invention. Since the optical pickup apparatus and the focus error detecting device of the present embodiment are similar to the optical pickup apparatus 30 and the focus error detecting device 31 of the first embodiment, an entire configuration view thereof will be omitted, and corresponding portions will be denoted by the same reference numerals to omit the description thereof.

A hologram pattern 61a formed on the hologram element 61 of the present embodiment has a plan-viewed shape formed into a circle. The circular hologram pattern 61a is split into a semicircular first region 63 and the remaining region by a first splitting line 62 that passes through the center of the circle and extends in the direction perpendicular to the track of the optical recording medium, and further, the remaining region is split into a second region 64 and a third region 65 by a second splitting line 40 that is orthogonal to the first splitting line 62.

The first region 63 of the hologram pattern 61a is split into a first concentric circle region 66 that is concentric with the circle of the hologram pattern 61a and partitioned off so as to become a semicircle, and first to third ring regions H11, H12, H13 that are partitioned off, respectively, on the outer perimeter portion of the first concentric circle region 66. The first ring region H11 locates on the virtual line 45 as the extension line of the second splitting line 40, and partitioned off so as to become symmetrical about the virtual line 45. The second and third ring regions H12, H13 are partitioned off in positions adjacent to the first ring region H11, respectively, and symmetrical about the virtual line 45.

Further, inward the second and third regions 64, 65, a second concentric circle region H14 that is concentric with the circle of the hologram pattern 61a and partitioned off so as to become a semicircle. In the present embodiment, the second concentric circle region H14 is partitioned off so that the area thereof becomes smaller than that of the first concentric circle region 66.

A plurality of light beams split by the hologram pattern 61a partitioned off and formed in this manner form concentric circular shapes or concentric ring shapes with the circle of the hologram pattern 61a, respectively, in cross sections perpendicular to the optical axes of the light beams.

Assuming, as to the falling positions of light beams on the two split light-receiving segments 37a, 37b in the present embodiment, a position on the segment splitting line 51 is a position A, a point on the light receiving segment 37a and away from the position A in the direction perpendicular to the segment splitting line 51 is a position B, and a point on the light receiving segment 37b and away from the position A in the direction perpendicular to the segment splitting line 51 is a position C, light beams split by the first to third ring regions H11, H12, H13 and the second concentric circle region H14 are caused to fall on positions shown in Table 2, respectively.

That is to say, light beams diffracted by the first ring region H11 fall on the position A and the position B, light beams diffracted by the second and third ring regions H12, H13 and the second concentric circle region H14 fall on the position C.

TABLE 2

| Split region in | Falling position of |
|---|---|
| hologram pattern | light beam |
| H11 | A, B |
| H12 | C |
| H13 | C |
| H14 | C |

In the focus error detecting device provided with the hologram element 61, it is possible to adjust the position of the hologram element 61 and make a reflected light from the optical recording medium pass through around the center of the hologram pattern 61a. Therefore, by splitting a reflected light so as to become smaller concentrically, symmetries of lights entering the split regions become good, and it is possible to further stabilize the characteristic of focus error signals.

Although the focus error detecting device is installed in the optical pickup apparatus in the present embodiment as mentioned above, without being limited thereto, it may be installed in an apparatus for optically measuring a distance, for example.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A focus error detecting device comprising:
a light source for emitting light;
an objective lens for condensing light emitted from the light source on a reflector;
a two-part split photodetector for enter of part of light reflected by the reflector thereinto and outputting a reflected light detection result, to control a distance between the objective lens and the reflector; and
light beam splitting means, disposed between the objective lens and the two-part split photodetector, for bending an optical path so that part of light reflected by the reflector enters the two-part split photodetector, and splitting a light beam of reflected light entering the two-part split photodetector, into a plurality of parts.

2. The focus error detecting device of claim 1, wherein the light beam splitting means is a hologram element provided with a hologram pattern having regions split into a plurality of parts.

3. The focus error detecting device of claim 2, wherein the hologram pattern has a splitting line which splits the hologram pattern into at least two regions, and
a light beam split into a plurality of parts by the hologram element is condensed on the hologram pattern so as to have equal areas on both sides of a virtual line orthogonal to the splitting line.

4. The focus error detecting device of claim 3, wherein the hologram pattern is formed into a circle, and the splitting line extends in parallel to the diameter in a position which is at a predetermined distance away from a center of the circle of the hologram pattern.

5. The focus error detecting device of claim 1, wherein a plurality of light beams split by the light beam splitting means, in cross sections perpendicular to optical axes of the light beams, are of fan-shapes which are formed by splitting a substantially semicircle and have equal areas to each other.

6. The focus error detecting device of claim 1, wherein a plurality of light beams split by the light beam splitting means form, in cross sections perpendicular to the optical axes of the light beams, concentric circles or parts of concentric circles.

7. An optical pickup apparatus which records information on an optical recording medium and/or reproduces information from an optical recording medium by the use of light, the optical pickup apparatus comprising the focus error detecting device of claim 1.
